(19) United States
(12) Patent Application Publication
(10) Pub. No.: US 2025/0353083 A1
(43) Pub. Date: Nov. 20, 2025

(54) Cutting Tool With Flat Sided Groove For Non Rotation

(71) Applicant: Kennametal Inc., Latrobe, PA (US)

(72) Inventors: Thomas J. Long, Greensburg, PA (US); James R. Geyer, Manns Choice, PA (US)

(21) Appl. No.: 18/669,006

(22) Filed: May 20, 2024

(51) Int. Cl. B23B 31/00; B23B 31/107

(52) U.S. Cl. CPC B23B 31/005; B23B 31/107; B23B 2231/0268; B23B 2270/06

(57) ABSTRACT

A cutting tool includes a cutting bit having a cutting element and a cylindrical shank located below said cutting element and wherein said cylindrical shank has a clip groove having at least one surface that is at least one flat side, at least one convex surface, or at least one concave surface. The surface of the clip groove of the cylindrical shank biases against at least one of an internal radial tab of a retainer sleeve to inhibit axial movement and to inhibit rotation of the cylindrical shank of the cutting tool.

### CROSS-REFERENCE TO RELATED APPLICATION

Not applicable.

### STATEMENT REGARDING FEDERALLY SPONSORED RESEARCH OR DEVELOPMENT

Not Applicable.

### BACKGROUND

### 1. Field of the Invention

The present invention relates to a cutting tool assembly employed, for example, in earth working or in road construction applications.

### 2. Description of the Background Art

Known cutting tool assemblies for earth working include a rotating cutting tool. However, in some cases, it is desirable for the cutting tool to be non-rotating. One particular type of cutting tool known as a polycrystalline diamond, or “PCD” tool can include a cutting bit including a PCD tip. Such PCD tips are more expensive and longer lasting than, for example, carbide tips. Related art PCD tips are, for example, fixedly assembled, along with a solid bolster, wear-resistant ring, and steel head portion, onto a shank, with the shank being attached to and held by a tool holder, for example, via engagement of the shank with a retainer and washer, in a manner in which the cutting bit is allowed to rotate relative to the holder. However, allowing the PCD tool to rotate can shorten the tool's lifespan, and so it can be beneficial for PCD tips to be used with non-rotating tools.

Non-rotating tools, however, may present their own challenges. For example, they may present a need to prevent axial movement and rotation of cutting tools during operation. Current tools use tapered press fits or screw designs to prevent rotation of the tool. Furthermore, current non-rotating PCD tools are difficult to replace and wear unevenly due to the fact that they are unable to be turned or indexed. Additionally, existing non-rotating tools are not interchangeable with rotating tools. A need therefore exists for a non-rotatable cutting tool that can be interchanged with an existing rotatable cutting tool in an existing tool holder, and is indexable.

### SUMMARY

Embodiments presented herein may address and/or overcome one or more of the above disadvantages of the background art. Embodiments may present a cylindrical shaft (i.e. shank) having a clip groove that has at least one surface that is at least one flat side. Another embodiment may present at least one convex surface, or at least one concave surface. The surface of the clip groove prevents axial movement of the cylindrical shank of the cutting tool and prevents rotation of the cylindrical shank of the cutting tool.

Embodiments relate to cutting tool assemblies. They may be employed, for example, in earth working or in road construction. Particular embodiments may relate to a cutting tool comprising a cutting bit having a cutting element and a cylindrical shank located below said cutting element and wherein said cylindrical shank has a clip groove (i.e. a recessed groove) having a flat side, a convex surface, or a concave surface. In other words, the surface of the clip groove is not a three-hundred-and-sixty-degree continuous circular surface. When installed in a cutting tool, the surface of the clip groove of the cylindrical shank may bias against an internal radial tab of a retainer sleeve to inhibit axial movement and to inhibit rotation of the cylindrical shank of the cutting tool. The current known retainer designs may be used with the cutting tool comprising a cylindrical shank having a clip groove having a surface having at least one flat side. In some embodiments, no special block system is required to attach a rotating tool to the same system as a non-rotating tool.

Embodiments may provide a cutting tool comprising a cutting bit having a cutting element and a cylindrical shank located below said cutting element and wherein said cylindrical shank has a clip groove having at least one surface that is selected from the group consisting of at least one flat side, at least one convex surface, and at least one concave surface is provided.

In certain embodiments, a cutting tool assembly includes a cutting tool as described in the previous paragraph, a cutting bit holder having an internal cylindrical bore, and a cylindrical retainer sleeve, wherein said cylindrical shank fits inside said cylindrical retainer sleeve, and wherein said at least one surface of said clip groove of said cylindrical shank biases against said retainer sleeve to inhibit axial movement and radial rotation of said cylindrical shank of said cutting tool.

In certain embodiments, a cutting tool assembly includes a cutting bit having a head comprising of a body located longitudinally below a cutting element and a shoulder located below said body, and a cylindrical shank that has an outer wall having a longitudinal length that extends in a longitudinal direction from below said shoulder, and wherein said cylindrical shank has a clip groove that is located on said outer wall of said cylindrical shank, and wherein said clip groove has at least one surface that is selected from the group consisting of at least one flat side, at least one convex surface, and at least one concave surface, a cutting bit holder having an internal cylindrical bore and a front face, and wherein said internal cylindrical bore has a mouth, and wherein said internal cylindrical bore has a longitudinal length that extends in a longitudinal direction of said cylindrical shank, a washer having a center hole, and wherein said washer is located between said shoulder of said cutting bit and said front face of said cutting bit holder, and a cylindrical retainer sleeve having an outer wall, said cylindrical retainer sleeve has a longitudinal length, and a split that is located on the circumference of said outer wall that forms an opening on said cylindrical retainer sleeve and wherein said split extends in a longitudinal direction along the longitudinal length of said cylindrical retainer sleeve, and wherein said retainer sleeve having at least one internal radial tab having a first convex portion, wherein said cylindrical retainer sleeve fits inside said internal cylindrical bore of said cutting bit holder, wherein said cylindrical shank fits inside said cylindrical retainer sleeve, and wherein said at least one internal radial tab biases against and is in juxtaposition to said at least one surface of said clip groove to inhibit axial movement and radial rotation of said cylindrical shank of said cutting tool.

These and other embodiments shall be described in more detail herein and in the drawings that show exemplary embodiments.

### BRIEF DESCRIPTION OF THE DRAWINGS

While various embodiments are illustrated in the drawings, the particular embodiments shown should not be construed to limit the claims. Various modifications and changes may be made without departing from the scope of the invention.

FIG. 1 shows a side cross sectional view of the cutting tool of a first embodiment with the cylindrical shank of the cutting tool within a cylindrical retainer sleeve.

FIG. 2 shows a side cross sectional view of the cutting tool of the first embodiment with the longitudinal external tab of the cylindrical retainer sleeve engaged with the mouth of the internal cylindrical bore of the cutting bit holder.

FIG. 3 shows a perspective view of a cylindrical shank of a cutting tool with a flat-sided clip groove according to the first embodiment.

FIG. 4A shows a side view of a cutting tool and tool holder according to the related art.

FIG. 4B shows a cutaway view along line A-A of FIG. 4A.

FIG. 4C shows a side view of the cutting tool and tool holder that is rotated 90° in comparison to FIG. 4A.

FIG. 4D shows a perspective view of the FIG. 4A cutting tool and tool holder.

FIG. 5A shows a front view of the cutting tool of a second embodiment.

FIG. 5B shows a first side view of the cutting tool of the second embodiment.

FIG. 5C shows a first perspective view of the cutting tool of the second embodiment.

FIG. 5D shows a second side view of the cutting tool of the second embodiment.

FIG. 5E shows a cutaway view of the flat sided clip groove along line A-A of FIG. 5D.

FIG. 5F shows a second perspective view of the cutting tool of the second embodiment.

FIG. 6A shows a side view of the cutting tool of the second embodiment installed in a retainer sleeve.

FIG. 6B shows a cutaway view along line A-A of FIG. 6B.

FIG. 7A shows a first perspective view of a retainer sleeve used with embodiments of the cutting tool.

FIG. 7B shows a top view of the FIG. 7A retainer sleeve.

FIG. 7C shows a second perspective view of the FIG. 7A retainer sleeve.

FIG. 7D shows a first side view of the FIG. 7A retainer sleeve.

FIG. 7E shows a front view of the FIG. 7A retainer sleeve.

FIG. 7F shows a second side view of the FIG. 7A retainer sleeve.

FIG. 7G shows a third perspective view of the FIG. 7A retainer sleeve.

FIG. 7H shows a bottom view of the FIG. 7A retainer sleeve.

FIG. 7I shows a fourth perspective view of the FIG. 7A retainer sleeve.

FIG. 8A shows a first perspective view of another retainer sleeve used with embodiments of the cutting tool.

FIG. 8B shows a first side view of the FIG. 8A retainer sleeve.

FIG. 8C shows a second perspective view of the FIG. 8A retainer sleeve.

FIG. 8D shows a top view of the FIG. 8A retainer sleeve.

FIG. 8E shows a front view of the FIG. 8A retainer sleeve.

FIG. 8F shows a bottom view of the FIG. 8A retainer sleeve.

FIG. 8G shows a third perspective view of the FIG. 8A retainer sleeve.

FIG. 8H shows a second side view of the FIG. 8A retainer sleeve.

FIG. 8I shows a fourth perspective view of the FIG. 8A retainer sleeve.

FIG. 9A shows a side view of a cutting tool according to a third embodiment.

FIG. 9B shows a perspective view of the cutting tool according to the third embodiment.

FIG. 9C shows a front view of the cutting tool according to the third embodiment.

FIG. 9D shows a cutaway view along line A-A of FIG. 9C.

FIG. 10A shows a first perspective view of another retainer sleeve used with embodiments of the cutting tool.

FIG. 10B shows a top view of the FIG. 10A retainer sleeve.

FIG. 10C shows a second perspective view of the FIG. 10A retainer sleeve.

FIG. 10D shows a first side view of the FIG. 10A retainer sleeve.

FIG. 10E shows a front view of the FIG. 10A retainer sleeve.

FIG. 10F shows a second side view of the FIG. 10A retainer sleeve.

FIG. 10G shows a third perspective view of the FIG. 10A retainer sleeve.

FIG. 10H shows a bottom view of the FIG. 10A retainer sleeve.

FIG. 10I shows a fourth perspective view of the FIG. 10A retainer sleeve.

FIG. 11A shows a front view of the cutting tool according to a fourth embodiment.

FIG. 11B shows a cutaway view along line A-A of FIG. 11A.

### DETAILED DESCRIPTION

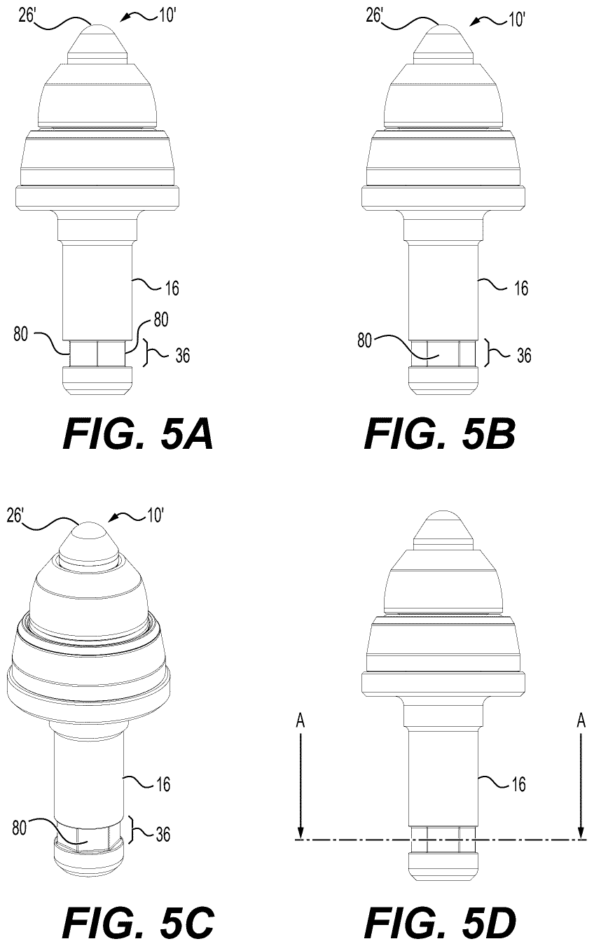

FIGS. 4A-4D illustrate shows a side view of a rotating cutting tool 10A according to the related art. The cutting tool (10A) has a recessed groove (36A) that is a three hundred and sixty degree (360°) continuous cylindrical surface. This arrangement allows rotation of the cylindrical shank (16A) and thus provides rotation of the cutting tool 10A relative to the cutting bit holder (18A).

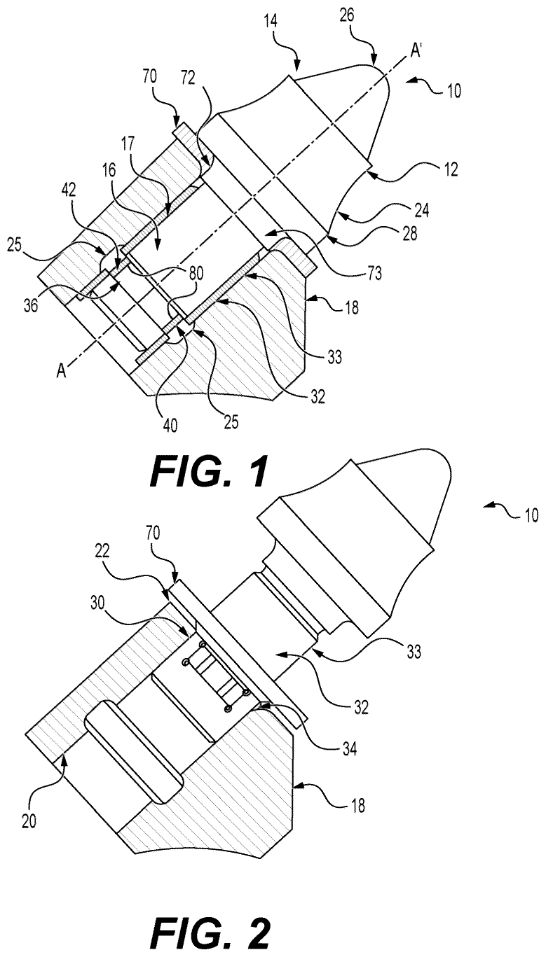

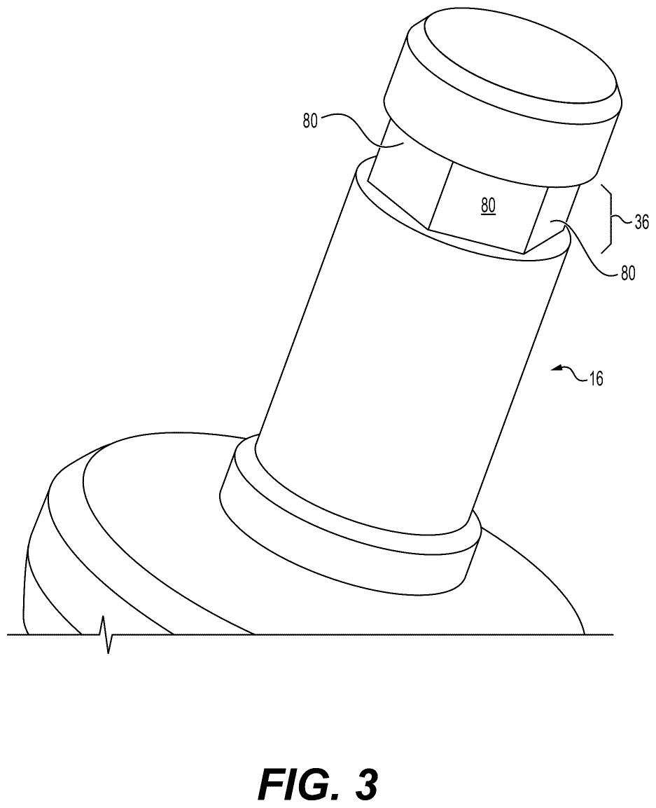

FIGS. 1-3 illustrate a cutting tool according to a first embodiment of the present application. The cutting tool (10) includes a cutting bit (12) having a head (14) comprising a body (24) located longitudinally below a cutting element (26), a shoulder (28) located longitudinally below the body (24), and a cylindrical shank (16) located longitudinally below the shoulder (28), and having a circumference smaller than that of the shoulder (28). In the illustrated embodiment, a non-PCD (e.g., carbide) cutting element (26) is shown, but of course a PCD cutting element can also be used. The cylindrical shank (16) has a clip groove (i.e. a recess groove) (36) located on an outer wall (17) of said cylindrical shank (16) and that differs from the continuous cylindrical surface of the related art cutting tool, in that it includes a pair of parallel flat surfaces (80) perpendicular to the tool axis. Alternatively, the surfaces (80) could be convex or concave, so long as they can engage with the radial tabs (40 and 42) to prevent relative rotation, as explained in detail below.

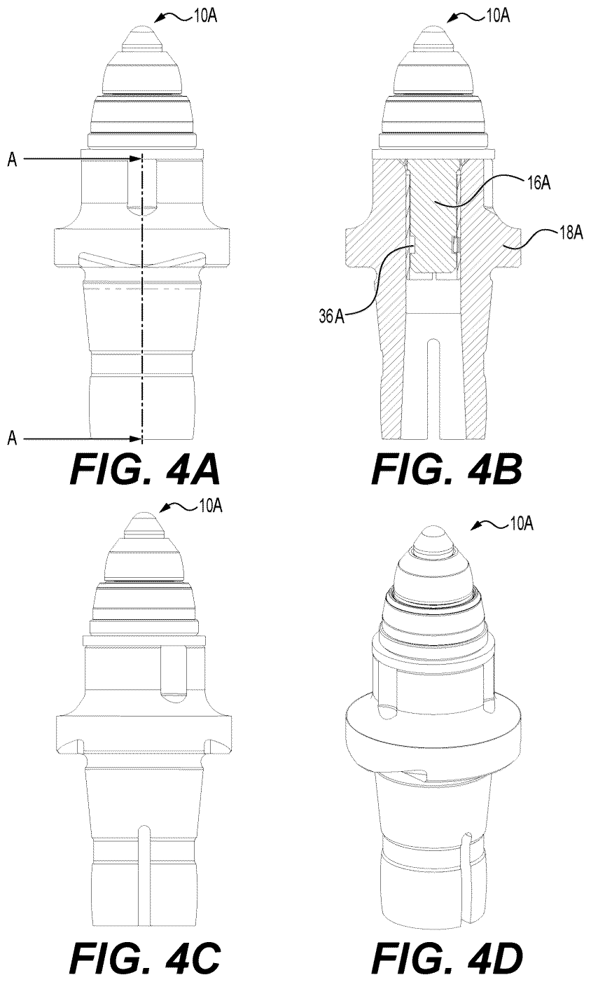

In the embodiment, as is evident from FIG. 3, there are a total of six surfaces (80), thus allowing the cutting tool (10) to be indexed in six different orientations. The number of surfaces (80), however, can be varied, as will be apparent from the additional embodiments discussed in detail below.

The cutting tool (10) is insertable in a cutting bit holder (18) having an internal cylindrical bore (20) that has a mouth (30) and an internal recessed radial groove (25). The bore (20) has a circumference larger than that of the shank (16) and large enough to tightly fit the shank (16) and a retainer sleeve (32) as discussed in detail below.

In the embodiment, a cylindrical retainer sleeve (32) that fits inside said internal cylindrical bore (20) of said cutting bit holder (18) retains the cutting tool (10) within the cutting bit holder (18). The cylindrical retainer sleeve (32) has an outer wall (33) and two internal radial tabs (40 and 42), each having a radially-inward facing convex portion which biases against and fits into said clip groove (36), such that the surfaces (80) of the clip groove (36) press against and are in juxtaposition with the respective internal radial tabs (40, 42) of said cylindrical retainer sleeve (32) to prevent axial movement and to prevent rotation of said cylindrical shank (16) of said cutting tool (10) relative to the retainer sleeve (32). Note that axial movement is preventable by virtue of the presence of engagement of the tabs (40, 42) with the groove (36) itself, and it is the inclusion of the surfaces (80) engageable with the tabs (40, 42) that prevents the rotational movement.

In the embodiment, the cylindrical retainer sleeve (32) has a radially outward projecting longitudinal external tab (34) located on the outer wall (33) at approximately the same axial position as the internal radial tabs (40 and 42), such that when said cylindrical shank (16) is fitted inside said cylindrical retainer sleeve (32) is positioned inside the bore (20), the longitudinal external tab (34) fits into said internal recessed radial groove (25). However, in alternative embodiments, the tab (34) is not provided on the retainer sleeve (32), and a friction fit is sufficient to keep the retainer sleeve (32) within the bore (20). In such embodiments, it is not necessary for the cutting bit holder (18) to have the internal recessed radial groove (25).

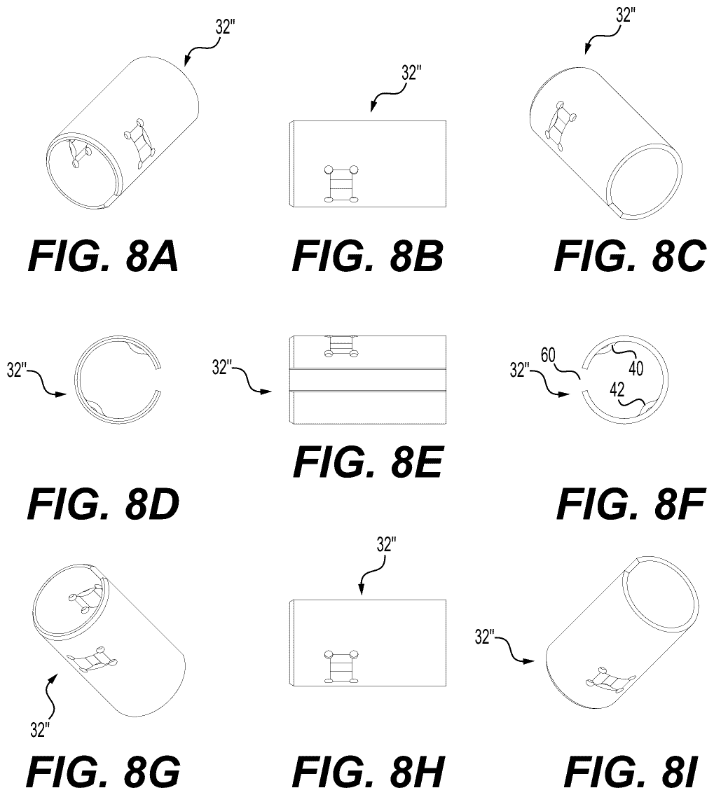

In the embodiment, in the installed state, there is a washer (70) having a center hole (72), located between the shoulder (28) of the cutting bit (12) and a front face (22) of the cutting bit holder (18). The retainer sleeve (32) in the embodiment is configured to have, in a free state, a circumference slightly larger than the circumference of the bore (20), and is slightly compressed when disposed within center hole (72) of the washer (70). In particular, as discussed in detail below, the retainer sleeve (32) has an axial split (60) along its entire longitudinal length (shown in FIG. 8F described in detail below, for example) allowing it to be compressed to a smaller size. In this regard, the retainer sleeve (32) is made of a compressible material, such as one of a 1070 or 65 Mn spring steel, with the opening of the axial split (60) having, for example, an uncompressed width of a maximum of 8 mm and a compressed width of a minimum of 1 mm.

During installation, the shank (16) of the cutting tool (10) is inserted into the retainer (32) until the tabs (40 and 42) and clip groove (36) engage, and then the retainer (32) is compressed by the washer (70), as discussed above. The retainer (32) along with the cutting tool (10), with the washer (70) positioned abutting against the front face (22), are then moved together axially into place in the bore (20) until the retainer (32) moves past the washer (70), at which point the retainer (32) is permitted to expand radially within the bore (20), and the washer (72) surrounds a hub (73) at an upper portion of the shank (16). In the embodiment, the hub (73) has a slightly larger diameter than the rest of the shank (16) to reduce the radial clearance of the washer (72).

The cutting tool (10) can be removed from the holder (18) by application of sufficient pressure to the rear of the cutting tool (10), and the retainer sleeve (32) will move as a unit with the cutting tool (10) out from the bore (20) by virtue of the engagement of the tabs (40 and 42) with the clip groove (36). If desired, the cutting tool (10) can be re-installed, while optionally being indexed by changing its orientation with respect to the bore (20).

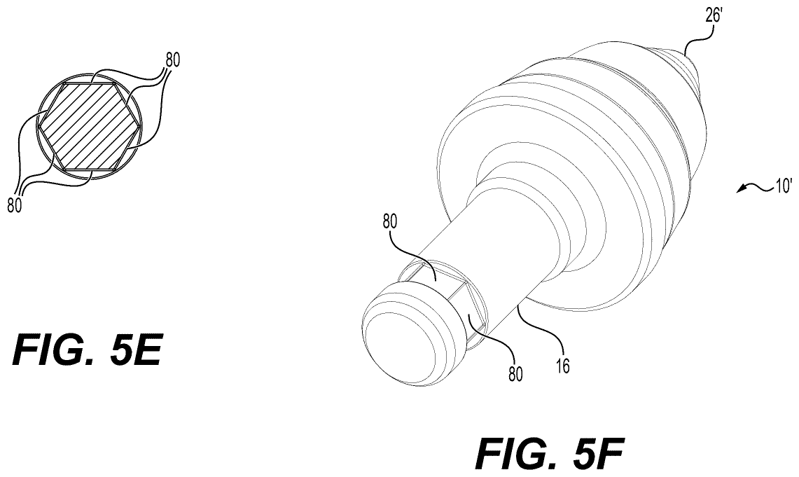

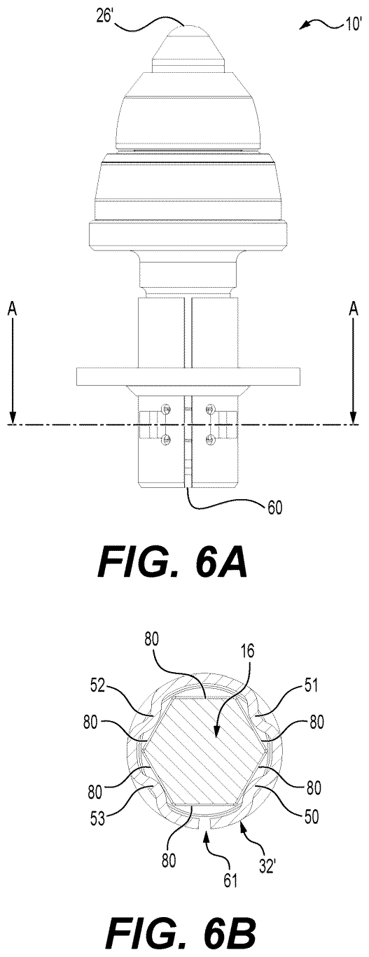

FIGS. 5A-5F and 6A-6B illustrate a cutting tool (10′) according to a second embodiment used with a retainer sleeve (32′) of a second embodiment. The cutting tool (10′) of the second embodiment is similar to the cutting tool (10) of the first embodiment of FIGS. 1-3, except that the cutting element (26′) is a PCD tip. As shown in those figures, the shank (16) has six surfaces (80) defining a hexagon in cross-section, similar to the cutting tool (10). The retainer sleeve (32′) of the second embodiment has four internal radial tabs (50, 51, 52, 53) in engagement with four of the six surfaces (80) of the shank (16). Furthermore, the FIG. 6C view illustrates the compressed state (61) of the split (60).

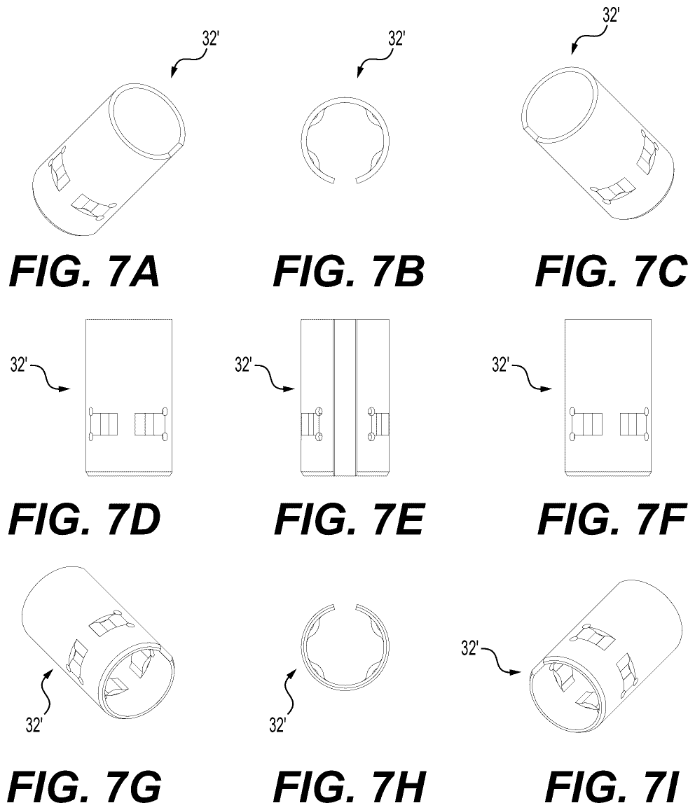

FIGS. 7A-7I illustrate several views of the retainer sleeve (32′) of FIGS. 6A-6B. The radial tabs and split of the retainer sleeve (32′) are arranged so that they will be arranged relative to the shank as illustrated in FIG. 6B.

FIGS. 8A-8I illustrate an exemplary retainer sleeve (32″) having two radial tabs (40, 42), approximately 180° apart, with the split 60 closer to tab (40). This retainer sleeve (32″) is similar to the retainer sleeve (32) used with the cutting tool of the first embodiment of FIGS. 1-3 described above, except that it lacks the optional longitudinal external tab (34).

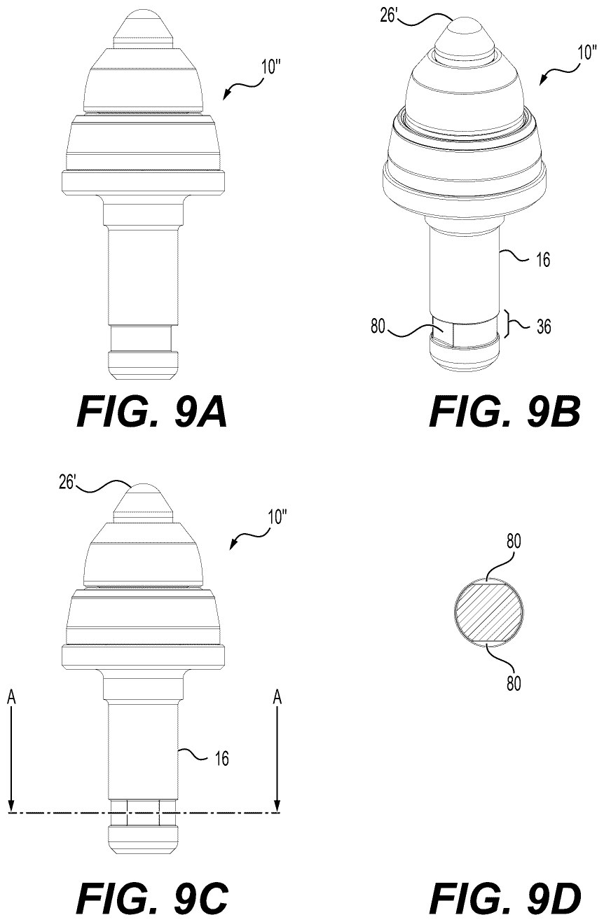

FIGS. 9A-9D illustrate a cutting tool (10″) according to a third embodiment. The cutting tool (10″) differs from the cutting tool (10) of the first embodiment of FIGS. 1-3 in that it has a cutting element (26′) that is a PCD tip, and differs from the cutting tool (10′) of the second embodiment of FIGS. 5A-5F and 6A-6B in that the clip groove (36) has two flat surfaces (80).

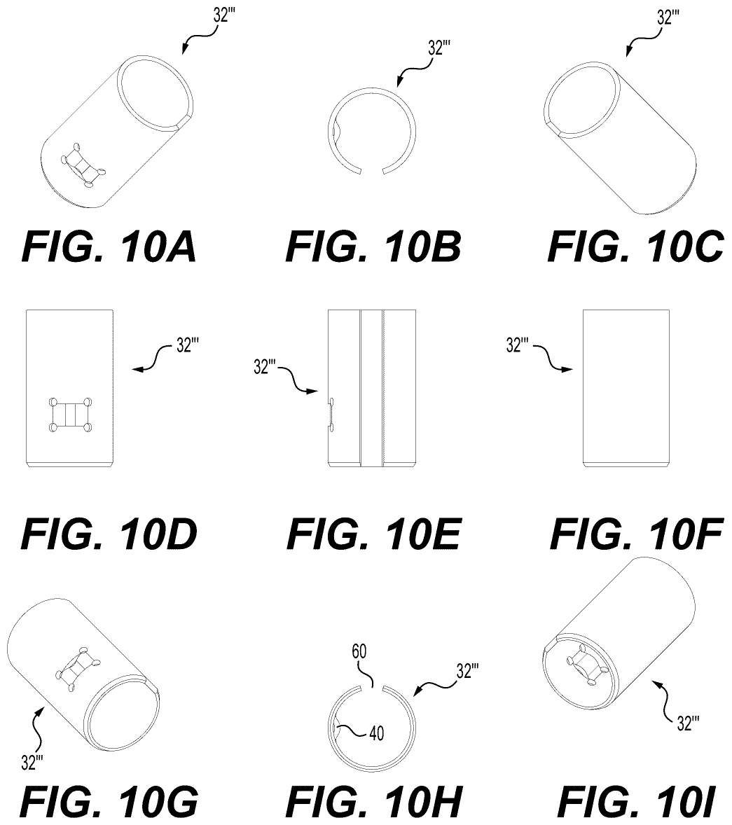

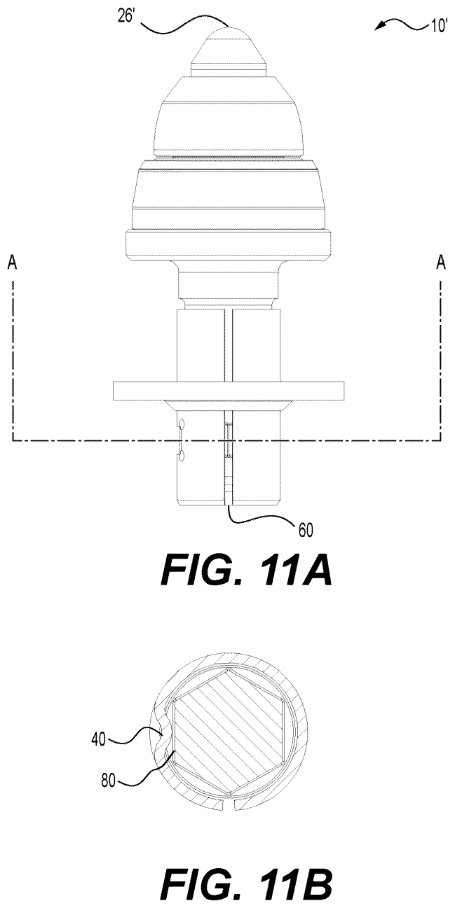

FIGS. 10A-10I illustrate an exemplary retainer sleeve (32′″) having a single radial tab (40) spaced approximately 90° from the split (60). FIGS. 11A and 11B illustrate the cutting tool (10′) using the retainer sleeve (32′″) of FIGS. 10A-10I, with one of the six surfaces (80) in engagement with the single radial tab (50).

As can be appreciated from the foregoing, a clip groove according to exemplary embodiments can have one or more flat sides, and/or one or more convex surfaces, and/or one or more concave surfaces, for example but not limited to two, three, four, five, or six flat sides, convex surfaces, and/or concave surfaces. The term “at least one” used herein therefore refers to one or more in number and is only constrained by the physical size of the clip groove surface of the cylindrical shank, thus it is possible that over 100 or more flat sides, convex surfaces, or concave surfaces may be physically arranged in a configuration around the length or circumference of a clip groove, depending on the overall size of the tool. The shape of the clip groove (i.e. recess groove) is other than (i.e. is not) a three hundred and sixty degree (360°) continuous circular surface that allows for free rotation of a shank of a cutting tool.

It will be appreciated by those persons skilled in the art that this disclosure sets forth a cutting tool that is a non-rotational cutting tool wherein one or more internal radial tabs each biases against and fits into at least one surface of a clip groove (i.e. a recess groove) that is located on an outer wall of a cylindrical shank. In certain embodiments, the retainer sleeve has a first internal radial tab having a first convex portion, a second internal radial tab having a second convex portion, a third internal radial tab having a third convex portion, and/or a fourth internal radial tab having a fourth convex portion, and wherein said first convex portion of said first internal radial tab, said second convex portion of said second internal radial tab, said third convex portion of said third internal radial tab, and/or said fourth convex portion of said fourth internal radial tab bias against and fit into at least one surface of a clip groove that is located on an outer wall of said cylindrical shank. The surface of said clip groove is at least one selected from the group consisting of at least one flat side, at least one convex surface, and at least one concave surface. It will be understood by those persons of skill in the art that the number of internal radial tabs provided will depend upon the diameter of the retainer ring, such that a large diameter retainer ring may require, for example, but not limited to, one or more internal radial tabs, or more than four internal radial tabs, in order to make the retainer ring stable.

As used herein, “juxtaposition” means in close proximity to or placed side by side.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

For purposes of the description above, it is to be understood that the invention may assume various alternative variations and step sequences except where expressly specified to the contrary. Moreover, all numbers expressing, for example, dimensions used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A cutting tool comprising:
a cutting bit having a cutting element; and
a cylindrical shank located below said cutting element,
wherein said cylindrical shank has a clip groove having at least one surface that is one selected from the group consisting of at least one flat side, at least one convex surface, and at least one concave surface.

2. The cutting tool of claim 1, wherein the clip groove has a flat side surface.

3. A cutting tool assembly comprising:
a cutting tool according to claim 1;
a cutting bit holder having an internal cylindrical bore; and
a cylindrical retainer sleeve,
wherein said cylindrical shank fits inside said cylindrical retainer sleeve, and
wherein said at least one surface of said clip groove of said cylindrical shank biases against said retainer sleeve to inhibit axial movement and radial rotation of said cylindrical shank of said cutting tool.

4. The cutting tool assembly of claim 3 wherein said outer wall of said cylindrical retainer sleeve has a split that forms an opening on said cylindrical retainer sleeve.

5. The cutting tool assembly of claim 3 wherein said cylindrical retainer sleeve is made of a compressible material.

6. The cutting tool assembly of claim 3, the retainer sleeve having a first internal radial tab having a first convex portion, a second internal radial tab having a second convex portion, a third internal radial tab having a third convex portion, and a fourth internal radial tab having a fourth convex portion, and wherein said first convex portion of said first internal radial tab, said second convex portion of said second internal radial tab, said third convex portion of said third internal radial tab, and said fourth convex portion of said fourth internal radial tab bias against and are in juxtaposition to said clip groove of said shank.

7. The cutting tool assembly of claim 3, wherein the cutting tool is interchangeable with a rotating cutting tool in the internal cylindrical bore of the cutting bit holder.

8. The cutting tool assembly of claim 3, wherein the cutting tool is configured to be removed from the internal cylindrical bore, and then indexed and replaced in the internal cylindrical bore.

9. A cutting tool assembly comprising:
a cutting bit having a head comprising of a body located longitudinally below a cutting element and a shoulder located below said body, and a cylindrical shank that has an outer wall having a longitudinal length that extends in a longitudinal direction from below said shoulder, and wherein said cylindrical shank has a clip groove that is located on said outer wall of said cylindrical shank, and wherein said clip groove has at least one surface that is one selected from the group consisting of at least one flat side, at least one convex surface, and at least one concave surface;
a cutting bit holder having an internal cylindrical bore and a front face, and wherein said internal cylindrical bore has a mouth, and wherein said internal cylindrical bore has a longitudinal length that extends in a longitudinal direction of said cylindrical shank;
a washer having a center hole, and wherein said washer is located between said shoulder of said cutting bit and said front face of said cutting bit holder; and
a cylindrical retainer sleeve having an outer wall, said cylindrical retainer sleeve has a longitudinal length, and a split that is located on the circumference of said outer wall that forms an opening on said cylindrical retainer sleeve and wherein said split extends in a longitudinal direction along the longitudinal length of said cylindrical retainer sleeve, and wherein said retainer sleeve having at least one internal radial tab having a first convex portion,
wherein said cylindrical retainer sleeve fits inside said internal cylindrical bore of said cutting bit holder,
wherein said cylindrical shank fits inside said cylindrical retainer sleeve, and
wherein said at least one internal radial tab biases against and is in juxtaposition to said at least one surface of said clip groove to inhibit axial movement and radial rotation of said cylindrical shank of said cutting tool.

10. The cutting tool assembly of claim 9 wherein said cylindrical shank has a circumference that is smaller than a circumference of said shoulder.

11. The cutting tool assembly of claim 9 wherein said internal cylindrical bore of said cutting bit holder has a circumference that is larger than the circumference of said cylindrical shank.

12. The cutting tool assembly of claim 9 wherein said washer has a center hole circumference that is larger than the circumference of said cylindrical shank and a center hole circumference that is smaller than the circumference of said shoulder.

13. The cutting tool assembly of claim 9 wherein said outer wall of said cylindrical retainer sleeve has a circumference that is smaller than the circumference of said internal cylindrical bore of said cutting bit holder.

14. The cutting tool assembly of claim 9 wherein said cylindrical retainer sleeve is made of a compressible material.

15. The cutting tool assembly of claim 9 wherein said opening of said split is about 8 millimeters in width in an uncompressed state, and wherein said opening of said split is compressed to a width of from less than about 8 millimeters to greater than about 1 millimeter.

16. The cutting tool assembly of claim 9 wherein the cutting bit is configured to be said opening of said split is about 8 millimeters in width in an uncompressed state, and wherein said opening of said split is compressed to a width of from less than about 8 millimeters to greater than about 1 millimeter.
